(19) United States
(12) Patent Application Publication
(10) Pub. No.: US 2001/0014155 A1
(43) Pub. Date: Aug. 16, 2001

(54) Method and apparatus for decrypting contents information

(76) Inventors: Takayuki Sugahara, Yokosuka-shi (JP); Seiji Higurashi, Tokyo (JP)

Correspondence Address: LAW OFFICES OF LOUIS WOO, 1901 North Fort Myer Drive, Suite 501, Arlington, VA, 22209, US

(21) Appl. No.: 09/740,843

(22) Filed: Dec. 21, 2000

(30) Foreign Application Priority Data
Feb. 16, 2000 (JP) 2000-37625

(51) Int. Cl. G06F 12/14; H04L 9/08

(52) U.S. Cl. 380/277; 705/51; 705/71

(57) ABSTRACT

A signal representative of a key is generated in response to key production information. Encryption-resultant contents information is decrypted in response to the generated signal representative of the key. Key-related information is received which has been generated by an external in response to an authentication value and at least a portion of the key production information according to a predetermined function. Issue ID information is received which has been generated in response to the authentication value and decryption-side ID information peculiar to a decryption side. The authentication value is reproduced from the decryption-side ID information and the received issue ID information. At least a portion of the key production information is generated from the reproduced authentication value and the received key-related information according to a function inverse with respect to the predetermined function.

### BACKGROUND OF THE INVENTION

1. Field of the Invention

This invention relates to a method of decrypting contents information. In addition, this invention relates to an apparatus for decrypting contents information.

2. Description of the Related Art

Japanese published unexamined patent application 10-269289 discloses a system for managing the distribution of digital contents. In the system of Japanese application 10-269289, a distributor side encrypts and compresses digital contents into processing-resultant digital contents. The distributor side transmits the processing-resultant digital contents, an encryption-resultant contents key, and encryption-resultant accounting information to a communication opposite party. The distributor side implements a process of receiving a charge on the basis of contents use information transmitted from the communication opposite party. Then, the distributor side implements a process of dividing the received charge among interested persons including a copyright holder of the digital contents. On the other hand, a user side (a digital contents player) decrypts and expands the processing-resultant digital contents in response to the contents key, thereby reproducing the original digital contents. The user side subjects the accounting information to a reducing process responsive to the use of the digital contents. The user side transmits the reduced accounting information and the contents use information to the distributor side.

Japanese published unexamined patent application 10-283268 discloses a system in which a recording medium stores encryption-resultant main information, and also encryption-resultant information representing a key for decrypting the encryption-resultant main information. Non-encrypted information representing conditions of decrypting the encryption-resultant main information is added to the encryption-resultant key information. In more detail, the encryption-resultant key information has non-encrypted control information which contains device information and region information. The control information is designed to prevent the encryption-resultant main information from being copied onto a magnetic recording medium or an optical disc in a user side for illegal use thereof.

The system of Japanese application 10-283268 has a problem as follows. The non-encrypted control information in the encryption-resultant key information can easily be altered by a third person. The alteration of the non-encrypted control information enables the third person to illegally copy the encryption-resultant main information.

### SUMMARY OF THE INVENTION

It is a first object of this invention to provide an improved method of decrypting contents information.

It is a second object of this invention to provide an improved apparatus for decrypting contents information.

A first aspect of this invention provides a method of decrypting contents information. The method comprises the steps of generating a signal representative of a key in response to key production information, the key being for decrypting encryption-resultant contents information; decrypting the encryption-resultant contents information in response to the generated signal representative of the key; receiving key-related information which has been generated by an external in response to an authentication value and at least a portion of the key production information according to a predetermined function; receiving issue ID information which has been generated in response to the authentication value and decryption-side ID information peculiar to a decryption side; reproducing the authentication value from the decryption-side ID information and the received issue ID information; and generating at least a portion of the key production information from the reproduced authentication value and the received key-related information according to a function inverse with respect to the predetermined function.

A second aspect of this invention provides a method of decrypting encryption-resultant contents information generated by an encryption side which implements the steps of generating a first-key signal representative of a first key from first-key base information being a base of the first key; encrypting contents information into encryption-resultant contents information in response to the first-key signal; generating a second-key signal representative of a second key from second-key base information being a base of the second key; encrypting at least a portion of the first-key base information to convert the first-key base information into encryption-resultant first-key base information in response to the second-key signal; and generating second-key-related information from the second-key base information and an authentication value according to a predetermined function. The method comprises the steps of receiving issue ID information which has been generated in response to the authentication value and decryption-side ID information peculiar to a decryption side; reproducing the authentication value from the decryption-side ID information and the received issue ID information; reproducing second-key base information from second-key-related information and the reproduced authentication value according to a function inverse with respect to the predetermined function; generating a second-key signal representative of a second key from the reproduced second-key base information; decrypting encryption-resultant first-key base information into original first-key base information in response to the generated second-key signal; generating a first-key signal representative of a first key from the original first-key base information; and decrypting encryption-resultant contents information into original contents information in response to the generated first-key signal.

A third aspect of this invention provides an apparatus for decrypting contents information. The apparatus comprises means for generating a signal representative of a key in response to key production information, the key being for decrypting encryption-resultant contents information; means for decrypting the encryption-resultant contents information in response to the generated signal representative of the key; means for receiving key-related information which has been generated by an external in response to an authentication value and at least a portion of the key production information according to a predetermined function; means for receiving issue ID information which has been generated in response to the authentication value and decryption-side ID information peculiar to a decryption side; means for reproducing the authentication value from the decryption-side ID information and the received issue ID information; and means for generating at least a portion of the key production information from the reproduced authentication value and the received key-related information according to a function inverse with respect to the predetermined function.

A fourth aspect of this invention provides an apparatus for decrypting encryption-resultant contents information generated by an encryption side which implements the steps of generating a first-key signal representative of a first key from first-key base information being a base of the first key; encrypting contents information into encryption-resultant contents information in response to the first-key signal; generating a second-key signal representative of a second key from second-key base information being a base of the second key; encrypting at least a portion of the first-key base information to convert the first-key base information into encryption-resultant first-key base information in response to the second-key signal; and generating second-key-related information from the second-key base information and an authentication value according to a predetermined function. The apparatus comprises means for receiving issue ID information which has been generated in response to the authentication value and decryption-side ID information peculiar to a decryption side; means for reproducing the authentication value from the decryption-side ID information and the received issue ID information; means for reproducing second-key base information from second-key-related information and the reproduced authentication value according to a function inverse with respect to the predetermined function; means for generating a second-key signal representative of a second key from the reproduced second-key base information; means for decrypting encryption-resultant first-key base information into original first-key base information in response to the generated second-key signal; means for generating a first-key signal representative of a first key from the original first-key base information; and means for decrypting encryption-resultant contents information into original contents information in response to the generated first-key signal.

A fifth aspect of this invention is based on the third aspect thereof, and provides an apparatus wherein the issue-ID-information receiving means comprises an input device for enabling a user to input the issue ID information.

A sixth aspect of this invention is based on the first aspect thereof, and provides a method wherein the issue-ID-information receiving step comprises receiving the issue ID information after it has been confirmed by a sender for the issue ID information that the decryption-side ID information is legitimate.

### BRIEF DESCRIPTION OF THE DRAWINGS

FIG. 1 is a block diagram of a system for contents information according to a first embodiment of this invention.

FIG. 2 is a diagram of a calculator in a primary section in FIG. 1.

FIG. 3 is a diagram of a signal generator in a secondary section in FIG. 1.

FIG. 4 is a block diagram of a portion of a system for contents information according to a second embodiment of this invention.

FIG. 5 is a block diagram of a portion of a system for contents information according to a third embodiment of this invention.

### DETAILED DESCRIPTION OF THE INVENTION

### First Embodiment

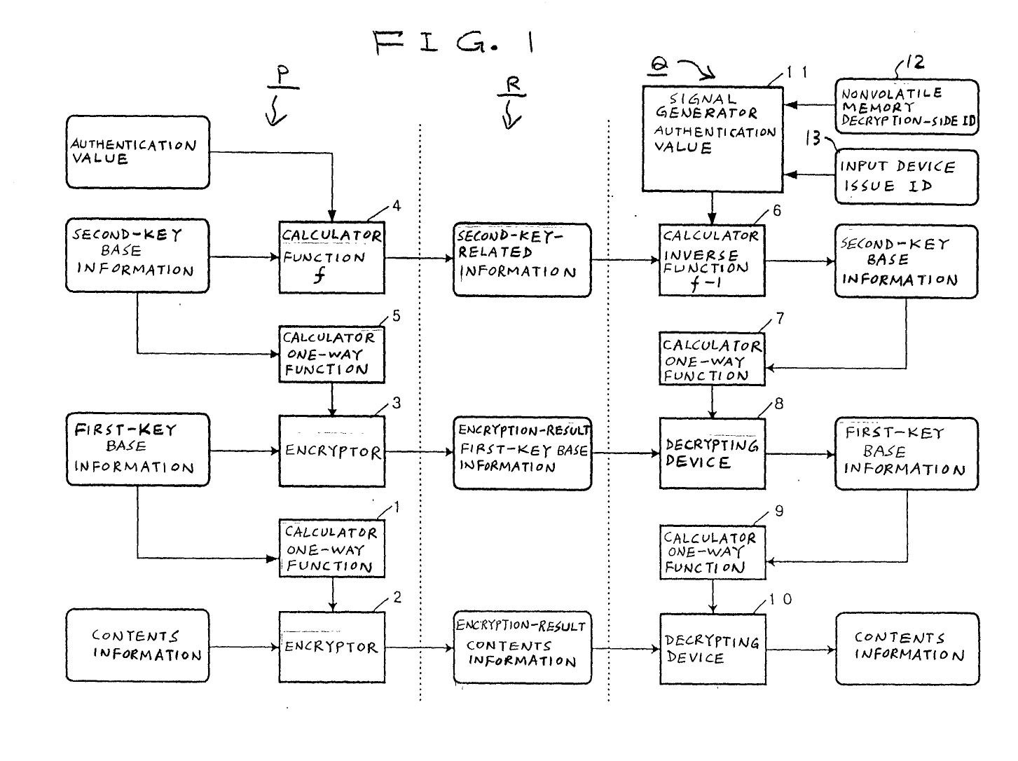

FIG. 1 shows a system for contents information according to a first embodiment of this invention. The system of FIG. 1 includes a primary section P, a secondary section Q, and an intermediate section R. The primary section P and the secondary section Q are connected to each other via the intermediate section R.

The primary section P includes an information recording apparatus or an information transmitting apparatus. The secondary section Q includes an information reproducing apparatus or an information receiving apparatus. An example of the information reproducing apparatus is an information player. The intermediate section R includes a recording medium or a transmission medium. Examples of the recording medium are a magnetic recording medium, an optical recording medium, and a semiconductor memory. Examples of the transmission medium are an optical fiber cable, electric wires, and a radio transmission line. The transmission medium is also referred to as a transmission line.

The primary section P includes a calculator or a key generator 1, encryptors 2 and 3, a calculator 4, and a calculator or a key generator 5. The calculator 1 receives information being a base of a first key, that is, a contents key. The first-key base information is fed from a suitable device (not shown). The calculator 1 generates a signal (information) representative of the first key from the first-key base information according to a predetermined one-way hash function. The calculator 1 outputs the first-key signal (the first-key information) to the encryptor 2. The one-way hash function means a function “h” designed to meet conditions as follows. When a certain value “x” is given in a domain of definition, it is difficult to calculate a value “y” which satisfies the relation as “h(x)=h(y)”.

The encryptor 2 receives contents information from a suitable device (not shown). The encryptor 2 encrypts the contents information into encryption-resultant contents information in response to the first-key signal. The encryptor 2 outputs the encryption-resultant contents information to the intermediate section R.

Specifically, the primary section P records the encryption-resultant contents information on the recording medium of the intermediate section R, or transmits the encryption-resultant contents information to the transmission line of the intermediate section R.

The encryptor 2 may additionally include a compressor. In this case, the compressor compresses the contents information, and then the encryptor 2 encrypts the compression-resultant contents information. The compression of the contents information is executed in a predetermined compressing method such as an MPEG (Moving Picture Experts Group) compressing method. It should be noted that compression-resultant contents information may be fed to the encryptor 2 from an external device (not shown). In this case, the compressor is omitted from the encryptor 2.

The encryption by the encryptor 2 may be based on a known encryption algorithm such as DES (Data Encryption Standard). According to DES, the contents information is encrypted and decrypted 64 bits by 64 bits in response to the first-key signal. In this case, the first-key signal corresponds to a 56-bit signal representing a common key. The encryption by the encryptor 2 includes a step of dividing every 64-bit block of the contents information (or the compression-resultant contents information) into a pair of 32-bit sub blocks. The encryption includes additional steps for signal processing on a sub-block by sub-block basis. The additional steps contain a step of transposing data, a step of executing permutation of data, a step of processing data according to a nonlinear function, and a step of executing Exclusive-OR operation between data.

The calculator 5 receives information being a base of a second key different from the first key. The second key may be equal to the first key. The second-key base information is fed from a suitable device (not shown). The calculator 5 generates a signal (information) representative of the second key from the second-key base information according to a predetermined one-way hash function. Preferably, the one-way hash function used by the calculator 5 differs from that used by the calculator 1. The one-way hash function used by the calculator 5 may be the same as that used by the calculator 1. The calculator 5 outputs the second-key signal (the second-key information) to the encryptor 3.

Preferably, the second-key base information differs from the first-key base information. In this case, specified 56-bit information peculiar to the primary section P (or the system) which differs from the specified 56-bit information for the base of the first key is set as the second-key base information.

The encryptor 3 receives the first-key base information. The encryptor 3 encrypts the first-key base information into encryption-resultant first-key base information in response to the second-key signal. The encryptor 3 outputs the encryption-resultant first-key base information to the intermediate section R.

Specifically, the primary section P records the encryption-resultant first-key base information on the recording medium of the intermediate section R, or transmits the encryption-resultant first-key base information to the transmission line of the intermediate section R.

The encryptor 3 may encrypt a part of the first-key base information in response to the second-key signal. For example, the encryptor 3 encrypts only an important portion or a designated portion of the first-key base information. Alternatively, the encryptor 3 may encrypt the whole of the first-key base information.

The calculator 4 receives information representative of a predetermined authentication value from a suitable device (not shown). The predetermined authentication value is also referred to as the specified authentication value. The calculator 4 also receives the second-key base information. The calculator 4 generates second-key-related information from the authentication-value information and the second-key base information according to a predetermined function “f”. The calculator 4 outputs the second-key-related information to the intermediate section R.

Specifically, the primary section P records the second-key-related information on the recording medium of the intermediate section R, or transmits the second-key-related information to the transmission line of the intermediate section R.

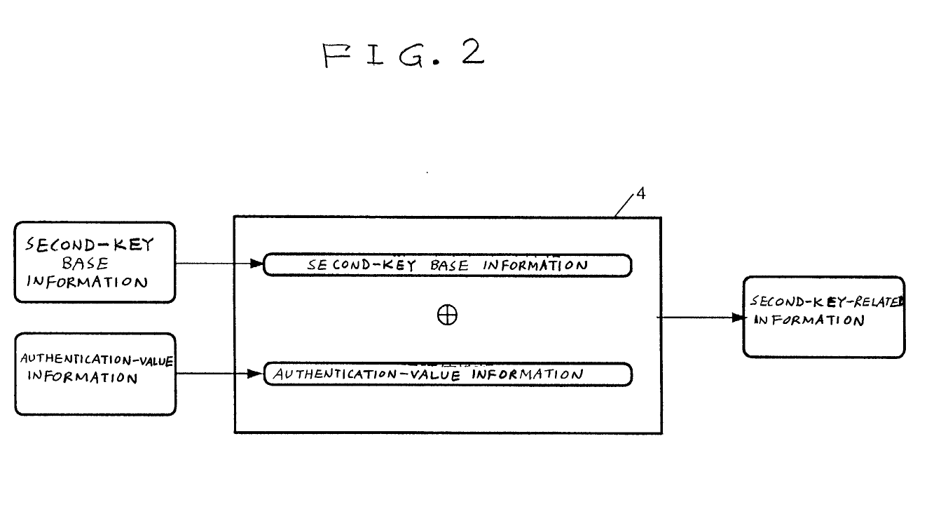

FIG. 2 shows an example of the calculator 4. The calculator 4 in FIG. 2 receives the second-key base information and the authentication-value information. The calculator 4 executes Exclusive-OR operation between the second-key base information and the authentication-value information. In this case, Exclusive-OR operation corresponds to the predetermined function “f”. The calculator 4 outputs the result of Exclusive-OR operation as the second-key-related information.

Auxiliary information may be added to the authentication-value information. In this case, the calculator 4 generates second-key-related information from the auxiliary-added authentication-value information and the second-key base information. The auxiliary information contains, for example, information about a region or regions corresponding to one or more countries, one or more zones, or one or more spaces. Only a legitimate user of the secondary section Q is permitted to have the same auxiliary information as that used by the primary section P.

The authentication value may be varied from contents information to contents information. The authentication value may be varied in accordance with the type of contents information. In these cases, issue identification (ID) information mentioned later varies from contents information to contents information, or varies in accordance with the type of contents information. Preferably, the information representative of the authentication value is generated by a contents-information provider before being transmitted therefrom to the primary section P. Generally, the contents-information provider is separate from the primary section P. Alternatively, the contents-information provider and the primary section P may be combined into a single station. Since the issue ID information is used as a portion of conditions of permitting decryption of encryption-resultant contents information as will be made clear later, the variation of the issue ID information in response to contents information enhances the ability to prevent the contents information from being illegally copied.

The encryption-resultant contents information, the encryption-resultant first-key base information, and the second-key-related information are transmitted from the primary section P to the secondary section Q through the intermediate section R.

The secondary section R includes a calculator 6, a calculator or a key generator 7, a decrypting device 8, a calculator or a key generator 9, a decrypting device 10, a signal generator 11, a nonvolatile memory 12, and an input device 13.

The nonvolatile memory 12 stores predetermined information peculiar to the secondary section Q, that is, identification (ID) information of the secondary section Q. The secondary-section ID information indicates a serial number of the secondary section Q.

The signal generator 11 receives the secondary-section ID information from the nonvolatile memory 12. In addition, the signal generator 11 receives issue ID information from the input device 13 as will be mentioned later. The signal generator 11 produces information representative of an authentication value from the secondary-section ID information and the issue ID information. The produced authentication value is the same as that used in the primary section P. The signal generator 11 outputs the authentication-value information to the calculator 6.

The issue ID information is generated by a contents-information provider. The secondary section Q which orders contents information notifies the contents-information provider of the secondary-section ID information. In the contents-information provider, the issue ID information is produced from information of the predetermined authentication value (the specified authentication value) and the ID information of the secondary section Q. The issue ID information is transmitted from the contents-information provider to the secondary section Q. Preferably, the contents-information provider is separate from the primary section P. The contents-information provider and the primary section P may be combined into a single station.

An example of a system related to the issue ID information is as follows. The contents-information provider has an issue-ID-information center. A user of the secondary section Q registers the ID information (the serial number) of the secondary section Q with the center via the Internet or a postcard. The center generates issue ID information in response to the secondary-section ID information and the authentication-value information. The center notifies the generated issue ID information to the user of the secondary section Q via the Internet or a postcard. The user inputs the issue ID information into the secondary section Q by operating the input device 13. The input device 13 includes a remote control device, a panel button set, a keyboard, or a machine interface. The center may transmit the issue ID information to the signal generator 11 in the secondary section Q via a communication network.

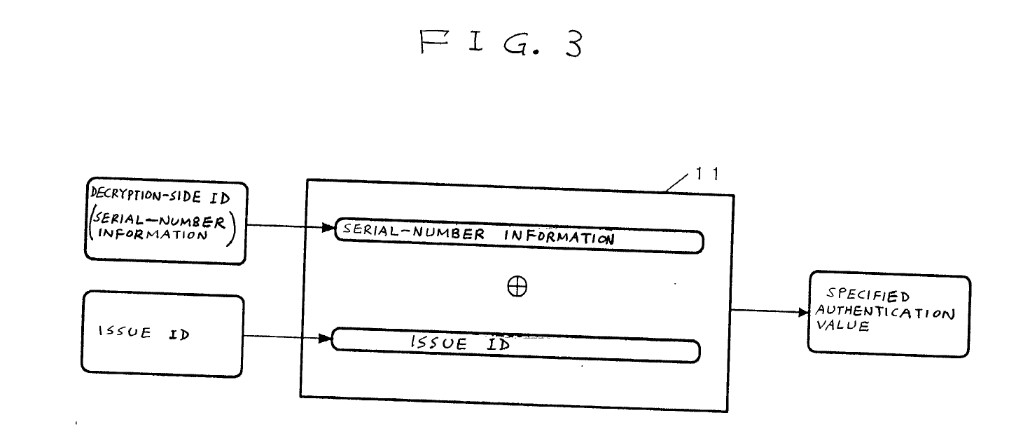

FIG. 3 shows an example of the signal generator 11. The signal generator in FIG. 3 receives the secondary-section ID information and the issue ID information. The signal generator 11 executes Exclusive-OR operation between the secondary-section ID information and the issue ID information. The signal generator 11 outputs the result of Exclusive-OR operation as the information of the specified authentication value.

For example, in the case where the serial number represented by the secondary-section ID information is “0xfafbfcfd” and the specified authentication value is “0xaabbccdd”, the contents-information provider generates “0x50403020” as the issue ID information in order to meet the following condition. The result of Exclusive-OR operation between the secondary-section ID information and the issue ID information which is executed by the signal generator 11 in the secondary section Q is “0xaabbccdd” equal to the specified authentication value.

In the case where wrong issue ID information is inputted into the secondary section Q, the signal generator 11 fails to generate a correct authentication value. As will be made clear later, the failure of the generation of the correct authentication value makes it difficult to reproduce correct second-key base information and to decrypt encryption-resultant contents information.

The issue-ID-information center in the contents-information provider may confirm whether the ID information fed from the secondary section Q is legitimate. In this case, the center generates the issue ID information and notifies the generated issue ID information to the user of the secondary section Q after confirming that the secondary-section ID information is legitimate. The generation of issue ID information for one authentication value may be executed only once per secondary section Q.

The calculator 6 receives the authentication-value information from the signal generator 11. The calculator 6 also receives the second-key-related information from the intermediate section R. The calculator 6 reproduces the second-key base information from the second-key-related information and the authentication-value information according to an inverse function “f⁻¹” with respect to the predetermined function “f” used in the primary section P. In the case where the auxiliary information is added to the authentication-value information by the primary section P, the calculator 6 reproduces the second-key base information from the second-key-related information, the authentication-value information, and the auxiliary information according to an inverse function “f⁻¹” with respect to the predetermined function “f” used in the primary section P. Only a legitimate user of the secondary section Q is permitted to have the same auxiliary information as that used by the primary section P. The calculator 6 outputs the reproduced second-key base information to the calculator 7.

For example, the calculator 6 executes Exclusive-OR operation between the second-key-related information and the authentication-value information. In this case, Exclusive-OR operation corresponds to the inverse function “f⁻¹” with respect to the predetermined function “f”. The calculator 6 outputs the result of Exclusive-OR operation as the second-key base information.

The calculator 7 generates a signal (information) representative of the second key from the second-key base information according to a predetermined one-way hash function equal to that used by the calculator 5 in the primary section P. The calculator 7 outputs the second-key signal (the second-key information) to the decrypting device 8.

The decrypting device 8 receives the encryption-resultant first-key base information from the intermediate section R. The decrypting device 8 decrypts the encryption-resultant first-key base information into the first-key base information in response to the second-key signal. The decrypting device 8 outputs the first-key base information to the calculator 9.

The calculator 9 generates a signal (information) representative of the first key from the first-key base information according to a predetermined one-directional hash function equal to that used by the calculator 1 in the primary section P. The calculator 9 outputs the first-key signal (the first-key information) to the decrypting device 10.

The decrypting device 10 receives the encryption-resultant contents information from the intermediate section R. The decrypting device 10 decrypts the encryption-resultant contents information into the original contents information in response to the first-key signal. Thus, the decrypting device 10 reproduces the original contents information. The-decrypting device 10 outputs the reproduced contents information.

As previously mentioned, the secondary section Q fails to reproduce correct second-key base information when legitimate issue ID information is not inputted thereinto. The failure of the reproduction of the correct second-key base information makes it difficult to decrypt the encryption-resultant first-key base information and also to decrypt the encryption-resultant contents information. Accordingly, illegal reproduction and illegal playback of the contents information can be reliably prevented.

Both the predetermined function “f” and its inverse function “f⁻¹” correspond to same logic operation, that is, Exclusive-OR operation. Both the predetermined function “f” and its inverse function “f⁻¹” may correspond to same logic operation other than Exclusive-OR operation. Alternatively, the predetermined function “f” and its inverse function “f⁻¹” may correspond to first logic operation and second logic operation respectively which differ from each other.

The first-key base information, the second-key base information, the authentication-value information, the secondary-section ID information, and the issue ID information have the same number of bits, for example, 56 bits. In the case where each of the first-key base information, the second-key base information, the authentication-value information, the secondary-section ID information, and the issue ID information has less than 56 bits, bits of “0” are added thereto as higher bits to complete 56-bit information. Each of the first-key base information, the second-key base information, the authentication-value information, the secondary-section ID information, and the issue ID information may have more than 56 bits. In this case, higher bits corresponding to a surplus over 56 bits are neglected.

In the above-mentioned embodiment of this invention, the hierarchy of encryption (decryption) has 2 layers. The hierarchy of encryption (decryption) may have N layers, where N denotes a predetermined natural number different from 2 or a predetermined natural number greater than 2. In the case where the hierarchy of encryption (decryption) has N layers, the embodiment of this invention may be applied to any 2 layers among the N layers.

### Second Embodiment

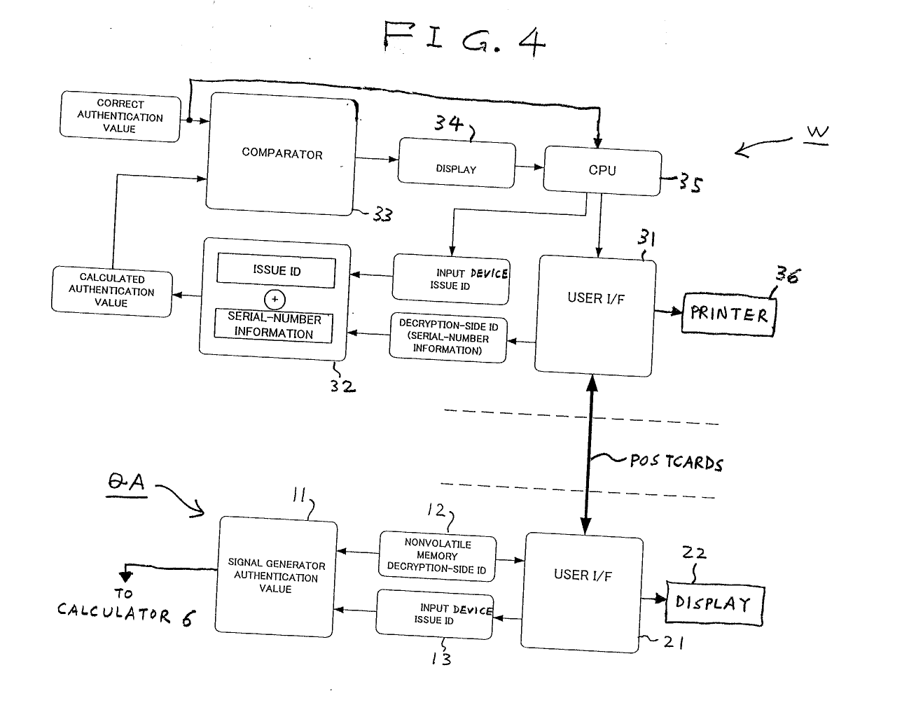

FIG. 4 shows a portion of a system for contents information according to a second embodiment of this invention. The system of FIG. 4 is similar to the system of FIG. 1 except for design changes mentioned later. The system of FIG. 4 includes a secondary section QA instead of the secondary section Q (see FIG. 1).

As shown in FIG. 4, the secondary section QA has a user interface 21 and a display 22. In other points, the secondary section QA is similar to the secondary section Q (see FIG. 1).

The system of FIG. 4 includes an issue-ID-information center W. The issue-ID-information center has a user interface 31, an authentication value generator 32, a comparator 33, a display 34, a CPU 35, and a printer 36.

A user of the secondary section QA operates the user interface 21 so that the ID information (the serial number) of the secondary section QA is read out from the memory 12, and is then indicated on the display 22. Thus, the user gets the secondary-section ID information. The user notifies the issue-ID-information center W of the secondary-section ID information via a postcard.

An operator of the issue-ID-information center W gets the secondary-section ID information from the postcard. The operator inputs the secondary-section ID information into the authentication value generator 32 by actuating the user interface 31. In the issue-ID-information center W, the CPU 35 executes Exclusive-OR operation between information of a correct authentication value and correct secondary-section ID information, thereby generating issue ID information. The CPU 35 feeds the issue ID information to the authentication value generator 32. The authentication value generator 32 executes Exclusive-OR operation between the issue ID information and the secondary-section ID information (that is, the ID information (the serial number) of the secondary section QA). The authentication value generator 32 defines the result of Exclusive-OR operation as a calculated authentication value. The authentication value generator 32 notifies the comparator 33 of the calculated authentication value.

In the issue-ID-information center W, the comparator 33 decides whether or not the correct authentication value and the calculated authentication value are equal to each other, that is, whether or not the ID information sent from the secondary section QA is legitimate. The comparator 33 outputs a signal representative of the decision result to the display 34. The display 34 indicates the decision result signal. Specifically, the display 34 indicates whether or not the correct authentication value and the calculated authentication value are equal to each other. In other words, the display 34 indicates whether or not the ID information sent from the secondary section QA is legitimate. The decision result signal is transmitted to the CPU 35 through the display 34. Only when the decision result signal represents that the correct authentication value and the calculated authentication value are equal to each other, the CPU 35 outputs the issue ID information to the user interface 31. Only when the display 34 indicates that the correct authentication value and the calculated authentication value are equal to each other, the operator actuates the user interface 31 so that the issue ID information is fed to the printer 36, and is then printed on a postcard by the printer 36. In this way, when the ID information sent from the secondary section QA is legitimate, the issue ID information is printed on the postcard. On the other hand, when the ID information sent from the secondary section QA is not legitimate, the CPU 35 and the user interface 31 are prevented from outputting the issue ID information. The postcard having the print of the issue ID information is sent to the user of the secondary section QA.

The user of the secondary section QA gets the issue ID information from the postcard. Then, the user inputs the issue ID information into the secondary section QA by operating the input device 13.

### Third Embodiment

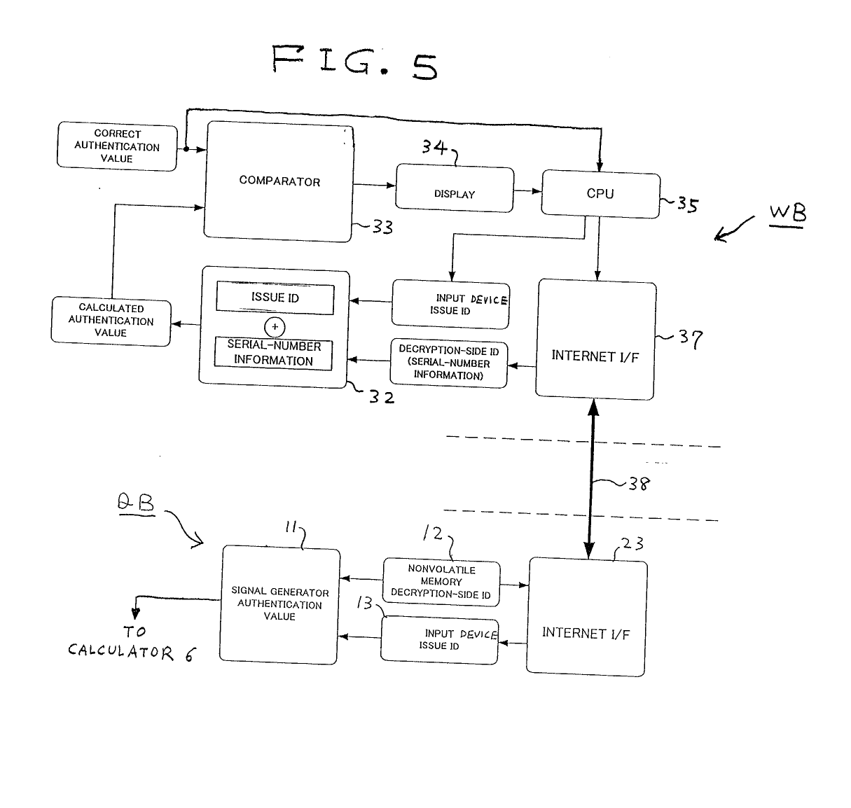

FIG. 5 shows a portion of a system for contents information according to a third embodiment of this invention. The system of FIG. 5 is similar to the system of FIG. 4 except for design changes mentioned later. The system of FIG. 5 includes a secondary section QB and an issue-ID-information center WB instead of the secondary section QA and the issue-ID-information center W (see FIG. 4).

As shown in FIG. 5, the secondary section QB has an Internet interface 23 which replaces the user interface 21 and the display 22 (see FIG. 4). In other points, the secondary section QB is basically similar to the secondary section QA (see FIG. 4).

As shown in FIG. 5, the issue-ID-information center WB has an Internet interface 37 which replaces the user interface 31 and the printer 36 (see FIG. 4). In other points, the issue-ID-information center WB is basically similar to the issue-ID-information center W (see FIG. 4).

A user operates the secondary section QB so that the Internet interface 23 thereof is connected with the Internet interface 37 in the issue-ID-information center WB via the Internet 38. The ID information (the serial number) of the secondary section QB is read out from the memory 12, and is then fed to the Internet interface 23. The Internet interface 23 transmits the secondary-section ID information to the Internet interface 37 of the issue-ID-information center WB.

In the issue-ID-information center WB, the Internet interface 27 feeds the secondary-section ID information to the authentication value generator 32. As in the second embodiment of this invention, the CPU 35 feeds the issue ID information to the authentication value generator 32. The authentication value generator 32 executes Exclusive-OR operation between the issue ID information and the secondary-section ID information (that is, the ID information (the serial number) of the secondary section QB). The authentication value generator 32 defines the result of Exclusive-OR operation as a calculated authentication value. The authentication value generator 32 notifies the comparator 33 of the calculated authentication value.

In the issue-ID-information center WB, the comparator 33 decides whether or not the correct authentication value and the calculated authentication value are equal to each other, that is, whether or not the ID information sent from the secondary section QB is legitimate. The comparator 33 outputs a signal representative of the decision result to the display 34. The display 34 indicates the decision result signal. Specifically, the display 34 indicates whether or not the correct authentication value and the calculated authentication value are equal to each other. In other words, the display 34 indicates whether or not the ID information sent from the secondary section QB is legitimate. The decision result signal is transmitted to the CPU 35 through the display 34. Only when the decision result signal represents that the correct authentication value and the calculated authentication value are equal to each other, the CPU 35 outputs the issue ID information to the Internet interface 37. Only when the display 34 indicates that the correct authentication value and the calculated authentication value are equal to each other, the operator actuates the Internet interface 37 so that the issue ID information is transmitted therefrom to the Internet interface 23 of the secondary section QB via the Internet 38. In this way, when the ID information sent from the secondary section QB is legitimate, the issue-ID-information center WB is permitted to transmit the issue ID information to the secondary section QB. On the other hand, when the ID information sent from the secondary section QB is not legitimate, the CPU 35 and the Internet interface 37 in the issue-ID-information center WB prevent the issue ID information from being transmitted to the secondary section QB.

The Internet interface 23 in the secondary section QB receives the issue ID information via the Internet 38. In the secondary section QB, the received issue ID information is transferred from the Internet interface 23 to the signal generator 11 through the input device 13.

What is claimed is:

1. A method of decrypting contents information, comprising the steps of:
generating a signal representative of a key in response to key production information, the key being for decrypting encryption-resultant contents information;
decrypting the encryption-resultant contents information in response to the generated signal representative of the key;
receiving key-related information which has been generated by an external in response to an authentication value and at least a portion of the key production information according to a predetermined function;
receiving issue ID information which has been generated in response to the authentication value and decryption-side ID information peculiar to a decryption side;
reproducing the authentication value from the decryption-side ID information and the received issue ID information; and
generating at least a portion of the key production information from the reproduced authentication value and the received key-related information according to a function inverse with respect to the predetermined function.

2. A method of decrypting encryption-resultant contents information generated by an encryption side which implements the steps of generating a first-key signal representative of a first key from first-key base information being a base of the first key; encrypting contents information into encryption-resultant contents information in response to the first-key signal; generating a second-key signal representative of a second key from second-key base information being a base of the second key; encrypting at least a portion of the first-key base information to convert the first-key base information into encryption-resultant first-key base information in response to the second-key signal; and generating second-key-related information from the second-key base information and an authentication value according to a predetermined function; the method comprising the steps of:
receiving issue ID information which has been generated in response to the authentication value and decryption-side ID information peculiar to a decryption side;
reproducing the authentication value from the decryption-side ID information and the received issue ID information;
reproducing second-key base information from second-key-related information and the reproduced authentication value according to a function inverse with respect to the predetermined function;
generating a second-key signal representative of a second key from the reproduced second-key base information;
decrypting encryption-resultant first-key base information into original first-key base information in response to the generated second-key signal;
generating a first-key signal representative of a first key from the original first-key base information; and
decrypting encryption-resultant contents information into original contents information in response to the generated first-key signal.

3. An apparatus for decrypting contents information, comprising:
means for generating a signal representative of a key in response to key production information, the key being for decrypting encryption-resultant contents information;
means for decrypting the encryption-resultant contents information in response to the generated signal representative of the key;
means for receiving key-related information which has been generated by an external in response to an authentication value and at least a portion of the key production information according to a predetermined function;
means for receiving issue ID information which has been generated in response to the authentication value and decryption-side ID information peculiar to a decryption side;
means for reproducing the authentication value from the decryption-side ID information and the received issue ID information; and
means for generating at least a portion of the key production information from the reproduced authentication value and the received key-related information according to a function inverse with respect to the predetermined function.

4. An apparatus for decrypting encryption-resultant contents information generated by an encryption side which implements the steps of generating a first-key signal representative of a first key from first-key base information being a base of the first key; encrypting contents information into encryption-resultant contents information in response to the first-key signal; generating a second-key signal representative of a second key from second-key base information being a base of the second key; encrypting at least a portion of the first-key base information to convert the first-key base information into encryption-resultant first-key base information in response to the second-key signal; and generating second-key-related information from the second-key base information and an authentication value according to a predetermined function; the apparatus comprising:
means for receiving issue ID information which has been generated in response to the authentication value and decryption-side ID information peculiar to a decryption side;
means for reproducing the authentication value from the decryption-side ID information and the received issue ID information;
means for reproducing second-key base information from second-key-related information and the reproduced authentication value according to a function inverse with respect to the predetermined function;
means for generating a second-key signal representative of a second key from the reproduced second-key base information;
means for decrypting encryption-resultant first-key base information into original first-key base information in response to the generated second-key signal;
means for generating a first-key signal representative of a first key from the original first-key base information; and
means for decrypting encryption-resultant contents information into original contents information in response to the generated first-key signal.

5. An apparatus as recited in claim 3, wherein the issue-ID-information receiving means comprises an input device for enabling a user to input the issue ID information.

6. A method as recited in claim 1, wherein the issue-ID-information receiving step comprises receiving the issue ID information after it has been confirmed by a sender for the issue ID information that the decryption-side ID information is legitimate.
